(19) United States
(12) Patent Application Publication
(10) Pub. No.: US 2006/0229074 A1
(43) Pub. Date: Oct. 12, 2006

(54) System and method for an inter-system VoIP handoff

(75) Inventor: William Joseph Semper, Richardson, TX (US)

Correspondence Address: Timothy F. Bliss, PO Box 793968, Dallas, TX, 75379-3968, US

(73) Assignee: Samsung Electronics Co., Ltd., Suwon-city (KR)

(21) Appl. No.: 11/395,007

(22) Filed: Mar. 31, 2006

Related U.S. Application Data
(60) Provisional application No. 60/668,742, filed on Apr. 6, 2005.

(51) Int. Cl. H04Q 7/20

(52) U.S. Cl. 455/436

(57) ABSTRACT

The present disclosure relates generally to systems and methods for an inter-system VoIP handoff. In one example, a method for handing off a VoIP call from an evolution-data only (EV-DO) network to a non-EV-DO network includes determining whether the VoIP call needs to be handed off to the non-EV-DO network, informing the non-EV-DO network that a VoIP handoff is needed, and handing off the VoIP call from the EV-DO network to the non-EV-DO network.

### CROSS REFERENCE

This application claims priority to U.S. Provisional Patent Ser. No. 60/668,742, entitled “INTER-SYSTEM VoIP HANDOFF”, filed on Apr. 6, 2005, which is hereby incorporated by reference in its entirety.

### BACKGROUND

Communications networks, such as those that can support voice and/or data, are generally deployed based on a particular standard. For example, networks based on code division multiple access (CDMA) technology are widely used and are typically associated with a particular version of the CDMA standard, such as cdma2000. A standard may also be grouped with other standards in a particular technology generation. For example, cdma2000 is generally designated as a 3G (third generation) network because it offers relatively high data speeds compared to second generation (2G) networks, as well as voice capabilities. Some network technologies have been developed to provide additional data capabilities. For example, an evolution-data only (EV-DO) standard has been developed to provide increased bandwidth for data. Such networks may overlay other networks, such as a cdma200 network.

To maintain an established communication session associated with a mobile device, the session may need to be transitioned (i.e., handed off) from one network to another as the mobile device leaves the coverage area of the network that is managing the session. However, such handoff methods between networks need improvement, particularly when moving from a network such as an EV-DO network to a non-EV-DO network.

### SUMMARY

In one embodiment, a system for handing off a voice over Internet Protocol (VoIP) call from an evolution-data only (EV-DO) first network to a non-EV-DO second network is provided. The system comprises an access network (AN) in the first network, a plurality of EV-DO cells accessible to the AN, and a plurality of instructions executable within the first network. The EV-DO cells are categorized by the AN as edge cells or non-edge cells. The plurality of instructions include instructions for recognizing when a mobile device associated with the call is located in an edge cell of the first network, identifying an adjacent cell of the second network positioned to receive the call from the edge cell, requesting a handoff of the call as a VoIP call to the second network; and directing the mobile device to the second network to continue the call, wherein the call is continued on the second network as a VoIP call.

In another embodiment, a method for handing off a voice over Internet Protocol (VoIP) call from an evolution-data only (EV-DO) network to a non-EV-DO network is provided. The method comprises determining, by the EV-DO network, whether the VoIP call needs to be handed off to the non-EV-DO network; informing the non-EV-DO network, by the EV-DO network, that a VoIP handoff is needed; and handing off the VoIP call from the EV-DO network to the non-EV-DO network.

In still another embodiment, a method for handing off a voice over Internet Protocol (VoIP) call from an evolution-data only (EV-DO) network to a non-EV-DO network is provided. The method comprises receiving, by the EV-DO network, a list of pilot signal strengths from a mobile device associated with the VoIP call, and determining that the VoIP call needs to be handed off to the non-EV-DO network if the list contains only edge cells of the EV-DO network. The method also includes identifying a cell of the non-EV-DO network that is positioned to receive the call, communicating with the non-EV-DO network to prepare for the handoff, and instructing the mobile device to switch to the non-EV-DO network to continue the call as a VoIP call.

In yet another embodiment, an access network (AN) in an evolution-data only (EV-DO) network is provided. The AN comprises a processor, a memory accessible to the processor, and a plurality of instructions stored in the memory. The instructions include instructions for identifying whether a mobile device associated with a voice over Internet Protocol (VoIP) call in the EV-DO network needs be handed off to a non-EV-DO network; requesting that the non-EV-DO network prepare for the handoff; receiving a notification that the non-EV-DO network is ready for the handoff; and directing the mobile device to switch to the non-EV-DO network to sustain the VoIP call.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart illustrating one embodiment of a method for executing an inter-system handoff.

FIG. 2 is a diagram of one embodiment of an EV-DO network.

FIG. 3 is a diagram of one embodiment of a 3G network, such as a cdma2000 network.

FIG. 4 is a diagram of one embodiment of a system with an EV-DO network coupled to a 3G network.

FIG. 5 illustrates one embodiment of a system having overlapping cells from two different networks.

FIG. 6 is a flowchart illustrating one embodiment of a method for executing an inter-system handoff.

FIG. 7 is a diagram illustrating one embodiment of a message sequence that may be used for executing an inter-system handoff.

### DETAILED DESCRIPTION

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

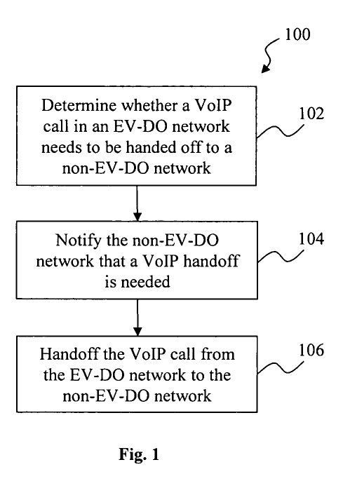

Referring to FIG. 1, one embodiment of a method 100 for handing off a communication session, such as a VoIP call, from an EV-DO network to another network is illustrated. The other network is a non-EV-DO network, such as a cdma2000 network. In step 102, a determination is made as to whether a mobile device associated with the call in the EV-DO network needs to be handed off to the other network. For example, as will be described later in greater detail, the handoff determination may be based on information regarding the location of the mobile device with respect to one or more edge cells in the EV-DO network. If a handoff is needed, the EV-DO network notifies the other network that a handoff is needed in step 104. In step 106, the call is handed off to the other network. More detailed examples of steps 102, 104, and 106 are provided below.

In the present embodiment, the method 100 enables the handoff to occur from the EV-DO network to the other network while maintaining the call as a VoIP call. However, in other embodiments, it is understood that the VoIP call may become a circuit-switched call when transferred to the other network. Examples of architectures in which such circuit-switched embodiments may be performed are disclosed in standards such as TIA878-B and TIA1878-B, both of which are incorporated herein by reference.

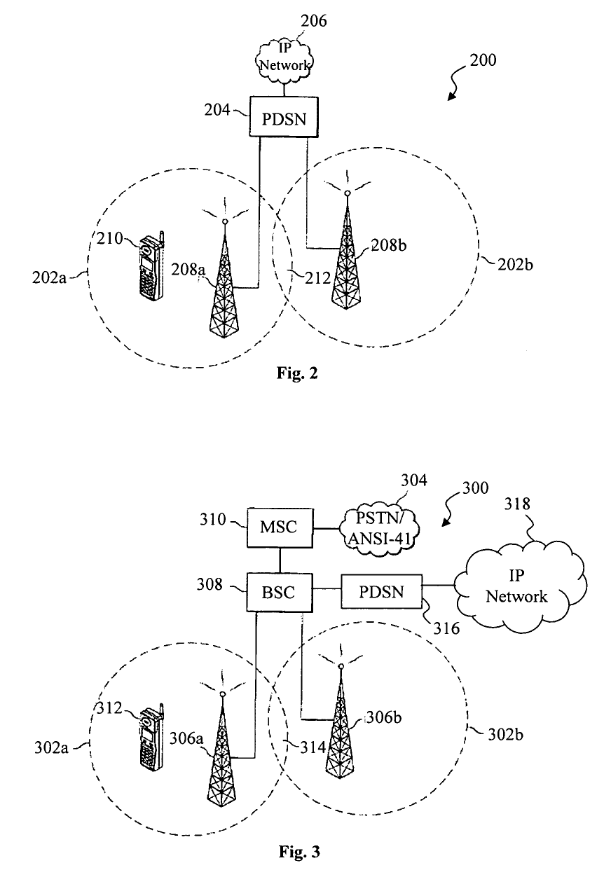

Referring to FIG. 2, a communications network 200 illustrates one embodiment of an EV-DO system in which the method 100 of FIG. 1 may be practiced. The network 200 comprises a plurality of cells 202a, 202b. In the present example, the network 200 is a wireless network, and may be connected to other wireless and/or wireline networks via packet data serving node (PDSN) 204 that is coupled to an IP network 206, such as the Internet. Each cell 202a and 202b in the network 200 includes an access network (AN) 208a, 208b, respectively. The ANs 208a and 208b may be standalone or may coexist in a shared radio facility, such as a base transceiver station (BTS) in a CDMA network (not shown).

The network 200 enables a mobile device 210 to communicate with another device (not shown) via the AN 208a associated with the cell 202a in which the mobile device is located. For example, the mobile device 210 may establish a VoIP call via the AN 208a. Such a call may be routed to another device within the EV-DO network 200 (e.g., a device within the cell 208b) or may be routed to a device outside the EV-DO network via IP network 206.

It is understood the mobile device 210 may be any device capable of communicating via the EV-DO network 200. For example, the device 210 may be a cellular phone, personal digital assistant (PDA), or computer able to communicate wirelessly. The device with which the mobile device 210 is communicating may be any device capable of such communications and may communicate via a wireless and/or wireline connection.

The cells 202a and 202b may overlap so that the mobile device 210 can travel from one cell to another (e.g., from the cell 202a to the cell 202b) while maintaining a communication session. In a “handoff” region 212 (e.g., the area where the cells 202a and 202b overlap), the mobile device 210 may be serviced by both the AN 208a and AN 208b.

Referring to FIG. 3, a non-EV-DO communications network 300 illustrates one embodiment of a system that may be used with the method 100 of FIG. 1. In the present example, the network 300 is a CDMA network that may be compatible with a variety of standards including, but not limited to, Interim Standard 95 (IS-95), Interim Standard 2000 (IS-2000) and Universal Mobile Telecommunications System (UMTS). The network 300 may represent other technologies, including Global System for Mobile communication (GSM), and Orthogonal Frequency Division Multiplexing (OFDM). It is understood that the methods of the present disclosure may be performed in networks based on different technologies, and that the examples using a CDMA network are for purposes of illustration only.

The network 300 comprises a plurality of cells 302a, 302b. In the present example, the network 300 is a wireless network, and may be connected to other wireless and/or wireline networks, such as a Public Switched Telephone Network (PSTN) 304. Each cell 302a, 302b in the network 300 includes a base transceiver station (BTS) 306a, 306b, respectively, which is connected to a base station controller (BSC) 308. A mobile switching center (MSC) 310 may be used to connect the network 300 with other networks such as the PSTN 304. The BSC 308 also connects to a PDSN 316 that is coupled to an IP network 318, such as the Internet. The network 300 enables a mobile device 312 to communicate with another device (not shown) via the BTS 306a associated with the cell 302a in which the mobile device is located.

The cells 302a, 302b overlap so that the mobile device 312 may travel from one cell to another (e.g., from the cell 302a to the cell 302b) while maintaining a communication session. In a “handoff” region 314 (e.g., the area where the cells 302a, 302b overlap), the mobile device 312 may be serviced by both the BTS 306a and the BTS 306b.

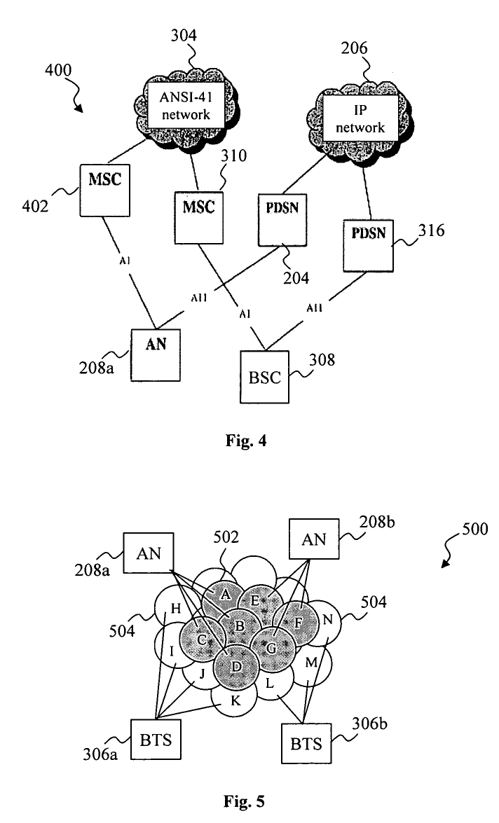

Referring to FIG. 4, a communications network 400 illustrates one embodiment of a system that includes an EV-DO network (e.g., a portion of the EV-DO network 200 of FIG. 2) coupled to a 3G1x network (e.g., a portion of the CDMA network 300 of FIG. 3). In the present example, AN 208a is coupled to the IP network 206 via PDSN 204 as described with respect to FIG. 2. The BSC 308 is coupled to the network 304 via the MSC 310 as described with respect to FIG. 3 and also to network 206 via PDSN 316. The BTS 306a is excluded from the present example for purposes of convenience.

In addition to the previously described connections, the AN 208a is also coupled to the network 304 via an MSC 402. It is understood that the MSC 310 and MSC 402 may be the same MSC, and the PDSN 204 and PDSN 316 may be the same PDSN in some embodiments. For example, if the EV-DO network 200 is introduced as an overlay to the CDMA network 300, then the AN 208a may be installed in the BSC 308. Accordingly, AN 208a and BSC 308 may be coupled to the same MSC and PDSN, although this is not required.

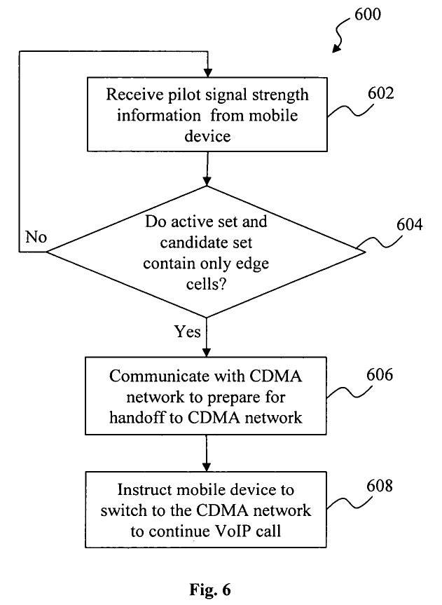

Referring to FIG. 5, in one embodiment, a communications network 500 illustrates a plurality of cells 502 and 504. The cells 502 and 504 are from two different networks that provide at least some overlapping coverage. In the present example, the cells 504 provide coverage beyond that provided by the cells 502. It is understood that the cells 504 include the coverage area of at least some of the cells 502. Furthermore, the illustration of cells 502 covering cells 504 is for purposes of illustration only and does not indicate any particular relationship between the cells 502 and cells 504.

The cells 502 are cells in an EV-DO network such as the network 200 of FIGS. 2 and 4. As such, the cells are coupled to AN 208a or AN 208b. For example, cells A-D are coupled to AN 208a and cells E-G are coupled to AN 208b. Cell B is not an edge cell, but cells A and C-G are edge cells. However, it is understood that the EV-DO network may have one or more edge cells that are not actually at the edge of the network. For example, if the cells 502 are relatively small (e.g., due to high usage, environmental limitations, etc., cells that are not actually on the edge of the network may be designated as edge cells. The AN 208a and AN 208b may be configured to know which cells 502 in the EV-DO network are edge cells.

The cells 504 are cells in a non-EV-DO network such as the network 300 of FIGS. 3 and 4, which is a 3G1x network in the present embodiment. As such, the cells are coupled to BTS 306a, 306b, or another BTS (not shown). For example, the cells H-K are coupled to the BTS 306a and the cells L-N are coupled to the BTS 306b. In addition to knowing which EV-DO cells 502 are edge cells, the AN 208a and AN 208b may be configured to know which cells 504 in the 3G1x network overlap with or are adjacent to the cells 502. For example, the AN 208a may be configured with the information that EV-DO cell D is adjacent to 3G1x cells J-L.

Referring to FIG. 6, in one embodiment, a method 600 may be executed within a system, such as the system 500 of FIG. 5, to achieve a handoff of a VoIP call from the EV-DO network to the 3G1x network. The method 600 is described from the perspective of the AN 208a (e.g., the AN 208a includes the functionality needed for the EV-DO side of the handoff), but the functionality provided by the method 600 may be implemented in other parts of the network. For purposes of example, the description of the method 600 begins with a mobile device (e.g., the mobile device 210 of FIG. 2) located in cell B and engaged in a VoIP call.

In step 602, the AN 208a receives pilot signal strength information from the mobile device 210. Under the 1xEV-DO air interface standard TIA-856-A, which allows for 3G1x messages to be sent over the 1xEV-DO air interface, the mobile device 210 may send a message, such as a RouteUpdate message, to the AN 208a. The message indicates which of the pilot signals are in an Active Set and which are in a Candidate Set. The Active Set contains pilot signals that are being received sufficiently strongly (e.g., above a certain threshold) for use by the mobile device 210 and that are actively involved in the VoIP call. The Candidate Set contains pilot signals that are not actively engaged in the call, but that are being received strongly enough that they may be added to the Active Set. It is noted that the AN 208a may make the final determination as to which pilots are added to the Active Set.

Although the Active and Candidate Sets are used in the present example, it is understood that other means may be used to determine whether the mobile device is in an edge node and needs to be handed off. For example, the actual strength of the pilot signals may be examined rather than simply whether they represent an edge cell or a non-edge cell. Accordingly, a pilot signal that is in the Candidate set but is relatively weak, or is weaker than it was in the previous Candidate list update, may not be factored into a determination of whether a handoff is needed.

The mobile device 210 sends a RouteUpdate message to the AN 208 whenever a pilot signal is added to or dropped from the Active and Candidate Sets. In the present example, the Active Set includes cells E and G. The candidate set includes F and D. This is illustrated below in Table 1.

TABLE 1

| Active Set | Candidate Set |
|---|---|
| B, D | C, G |

In step 604, the method 600 determines whether both the Active and Candidate sets contain only edge cells. As the Active Set currently contains cell B, which is a non-edge cell, the method returns to step 602.

In the present example, the mobile device 210 moves from cell B to cell D, and cell B is no longer actively involved in the call but is being received sufficiently strongly to be in the Candidate Set. At this point, the Active and Candidate Sets may be updated with cell B moving from the Active set to the Candidate set. This is reflected below in Table 2.

TABLE 2

| Active Set | Candidate Set |
|---|---|
| D | B, C, G |

Repeating step 604, the method 600 determines whether both the Active and Candidate sets contain only edge cells. As the Candidate Set currently contains cell B, which is a non-edge cell, the method again returns to step 602. It is noted that the mobile device 210 has moved into an edge cell at this point.

In the present example, the mobile device 210 moves towards the outer edge of cell D and the signal for cell B has become too weak to qualify for the Candidate Set. At this point, the Active and Candidate Sets may be updated to drop cell B from the Candidate Set. This is reflected below in Table 3.

TABLE 3

| Active Set | Candidate Set |
|---|---|
| D | C, G |

Repeating step 604, the method 600 determines whether both the Active and Candidate sets contain only edge cells. At this time, both the Active and Candidate Sets contain only edge cells. Based on this, the AN 208a identifies that the mobile device 210 is nearing the boundary of the 1xEV-DO network, and determines that a handoff to the 3G1x network is needed. The method continues to step 606.

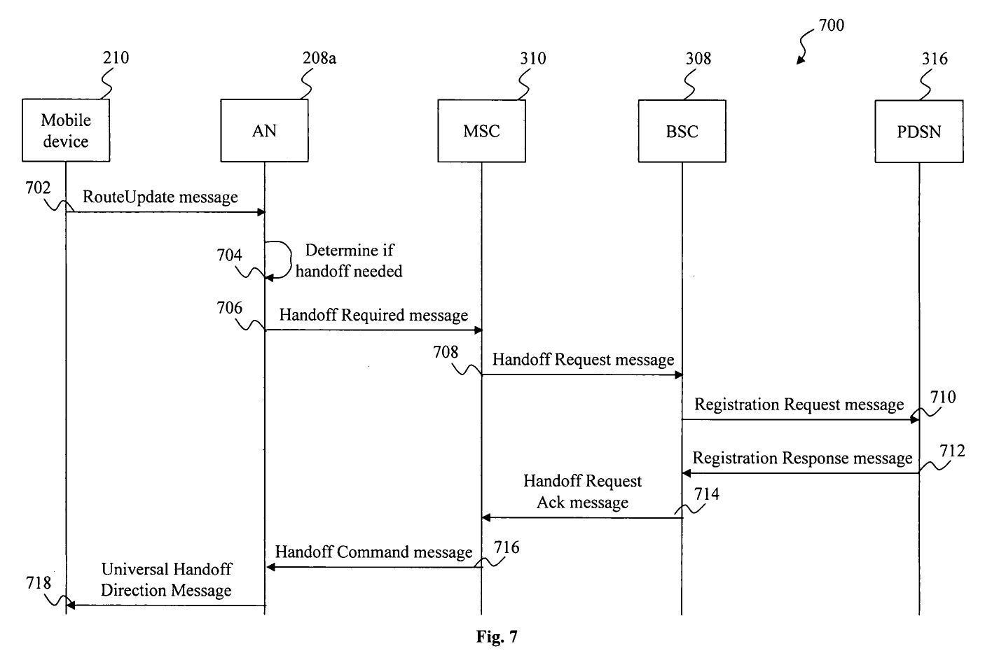

In step 606, the AN 208a executes a series of messages to hand the VoIP call off to the 3G1x network using, for example, signaling that is defined in standard TIA-2001-D. A more detailed example of such signaling is described below in reference to FIG. 7.

In step 608, after the network signaling has been completed, the AN 208a sends a message, such as a 3G1x Universal Handoff Direction Message (UHDM), to the mobile device 210 over the 1xEV-DO air interface. The message instructs the mobile device 210 to switch to the 3G1x network and the VoIP call continues on the 3G1x network.

Referring to FIG. 7, one embodiment of a message sequence 700 that may be used to hand off a VoIP call from an EV-DO network to a non-EV-DO (3G1x) network is illustrated. For purposes of example, the AN is the AN 208a of FIG. 4, the mobile device is the mobile device 210 of FIG. 1, the BCS is the BCS 308 of FIG. 4, the PDSN is the PDSN 316 of FIG. 4, and the MSC is the MSC 310 of FIG. 4. The AN 208a is also coupled to the MSC 310.

In step 702, the mobile device 210 sends a RouteUpdate message to the AN 208a indicating Active and Candidate Sets as described above with respect to FIG. 6. If the AN 208a determines in step 704 that the mobile device 210 is approaching the edge of the 1xEV-DO network based on the presence of only edge cells in the Active and Candidate Sets, the AN begins the process of handing off the VoIP call to the 3G1x network.

In step 706, the AN 208a sends IOS Handoff Required message to the MSC 310. The MSC 310 then sends an IOS Handoff Request message to the BSC 308 in step 708. It is understood that if the AN 208 and the BSC 308 are not connected to the same MSC, inter-MSC communication may be needed. Such inter-MSC communication is described in the IS-41 standard, which is hereby incorporated by reference in its entirety.

In step 710, the BSC 308 sends an IOS All Registration Request message to the PDSN 316 to establish an A10 connection for the VoIP call. Using information received in the IOS Handoff Request message, the BSC 308 may initiate a Fast Handoff that allows the PDSN 316 to contact a former PDSN (e.g., if the AN 208a and the BSC 308 are not connected to the same PDSN). The Fast Handoff allows the VoIP call to proceed un-interrupted on the BSC 308 after the handoff is completed.

In step 712, the PDSN 316 sends an IOS All Registration Response message to the BSC 308 to complete establishment of the A10 connection. In step 714, the BSC 308 sends an IOS Handoff Request Ack message to the MSC 310 to indicate it is ready to receive the VoIP call. In step 716, the MSC 310 sends an IOS Handoff Command message to the AN 208a to initiate handoff of the VoIP call to the BSC 308.

The messages between the MSC 310, BSC 308, and PDSN 316 may be performed in accordance with a specified standard, such as TIA-2001, which is hereby incorporated by reference. As stated previously, if the AN 208 and the BSC 308 are not connected to the same MSC, inter-MSC communication may be needed as described in previously incorporated IS-41. In step 718, the AN 208a sends a 3G1x Universal Handoff Direction Message to the mobile device 210, using the 3G Circuit Services protocol, to instruct the mobile device to tune to the BSC 308. As is known, the 3G Circuit Services Protocol enables the tunneling of a 3G1x message over the EV-DO network. The VoIP call can then continue on the 3G1x network. It is understood that the message sequence 700 and the particular messages described are only one example and that the functionality provided by the sequence 700 may be achieved using different sequences and/or messages.

Although only a few exemplary embodiments of this disclosure have been described in details above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. Accordingly, all such modifications are intended to be included within the scope of this disclosure.

What is claimed is:

1. A system for handing off a voice over Internet Protocol (VoIP) call from an evolution-data only (EV-DO) first network to a non-EV-DO second network, the system comprising:
an access network (AN) in the first network;
a plurality of EV-DO cells accessible to the AN, wherein the EV-DO cells are categorized by the AN as edge cells or non-edge cells; and
a plurality of instructions executable within the first network for:
recognizing when a mobile device associated with the call is located in an edge cell of the first network;
identifying an adjacent cell of the second network positioned to receive the call from the edge cell;
requesting a handoff of the call as a VoIP call to the second network; and
directing the mobile device to the second network to continue the call, wherein the call is continued on the second network as a VoIP call.

2. The system of claim 1 wherein the plurality of instructions for recognizing when the mobile device associated with the call is located in an edge cell of the first network include instructions for:
determining whether any non-edge cells are in a list of pilot signal strengths received by the AN from the mobile device; and
determining that the handoff is needed if the list contains only edge cells.

3. The system of claim 2 wherein the list of pilot signal strengths is divided into an Active Set and a Candidate Set, and wherein the handoff is needed only if both Sets contain only edge cells.

4. The system of claim 1 wherein the instructions for requesting a handoff of the call to the second network include instructions for:
sending a handoff required message to the second network; and
receiving a handoff command message from the second network.

5. A method for handing off a voice over Internet Protocol (VoIP) call from an evolution-data only (EV-DO) network to a non-EV-DO network, the method comprising:
determining, by the EV-DO network, whether the VoIP call needs to be handed off to the non-EV-DO network;
informing the non-EV-DO network, by the EV-DO network, that a VoIP handoff is needed; and
handing off the VoIP call from the EV-DO network to the non-EV-DO network.

6. The method of claim 5 wherein determining whether the call needs to be handed off to the non-EV-DO network includes determining whether a mobile device associated with the VoIP call in the EV-DO network is in an edge cell of the EV-DO network.

7. The method of claim 6 wherein the determining whether the mobile device is in an edge cell includes identifying whether a group of pilot signal strengths received from the mobile device contains only pilot signals from edge cells.

8. The method of claim 7 wherein the group of pilot signals is divided into an active set and a candidate set.

9. The method of claim 7 wherein the VoIP call needs to be handed off if only edge cells are represented in the group of pilot signal strengths.

10. The method of claim 5 wherein informing the non-EV-DO network includes:
sending a handoff required message to the non-EV-DO network; and
receiving a handoff command message at the EV-DO network from the non-EV-DO network notifying the EV-DO network to initiate the handoff to the non-EV-DO network.

11. The method of claim 5 wherein handing off the VoIP call from the EV-DO network to the non-EV-DO network includes notifying the mobile device, by the EV-DO network, to switch to the non-EV-DO network.

12. The method of claim 5 further comprising identifying, by the EV-DO network, at least one cell of the non-EV-DO network that is positioned to receive the handoff from an edge cell of the EV-DO network containing the mobile device.

13. A method for handing off a voice over Internet Protocol (VoIP) call from an evolution-data only (EV-DO) network to a non-EV-DO network, the method comprising:
receiving, by the EV-DO network, a list of pilot signal strengths from a mobile device associated with the VoIP call;
determining that the VoIP call needs to be handed off to the non-EV-DO network if the list contains only edge cells of the EV-DO network;
identifying a cell of the non-EV-DO network that is positioned to receive the call;
communicating with the non-EV-DO network to prepare for the handoff; and
instructing the mobile device to switch to the non-EV-DO network to continue the call as a VoIP call.

14. The method of claim 13 wherein communicating with the non-EV-DO network to prepare for the handoff includes:
sending the non-EV-DO network a handoff required message; and
receiving a handoff command message from the non-EV-DO network when the non-EV-DO network is ready to receive the handoff.

15. An access network (AN) in an evolution-data only (EV-DO) network comprising:
a processor;
a memory accessible to the processor; and
a plurality of instructions stored in the memory for:
identifying whether a mobile device associated with a voice over Internet Protocol (VoIP) call in the EV-DO network needs be handed off to a non-EV-DO network;
requesting that the non-EV-DO network prepare for the handoff;
receiving a notification that the non-EV-DO network is ready for the handoff; and
directing the mobile device to switch to the non-EV-DO network to sustain the VoIP call.

16. The AN of claim 15 wherein the instructions for identifying whether the mobile device needs to be handed off include:
receiving a list of pilot signals from the mobile device; and
determining that the mobile device needs to be handed off if only edge cells of the EV-DO network are in the list.

17. The AN of claim 16 wherein the list of pilot signals includes an active list and a candidate list.

18. The AN of claim 15 further comprising instructions for identifying at least one cell in the non-EV-DO network that is adjacent to an edge cell of the EV-DO network where the mobile device is located.
